(19) United States
(12) Patent Application Publication
(10) Pub. No.: US 2012/0021640 A1
(43) Pub. Date: Jan. 26, 2012

(54) COMMUNICATION CABLE

(75) Inventors: Kohei Masuda, Osaka (JP); Hiroshi Suenaga, Osaka (JP); Osamu Shibata, Hyogo (JP); Yoshiyuki Saito, Osaka (JP)

(73) Assignee: PANASONIC CORPORATION, Osaka (JP)

(21) Appl. No.: 13/257,560

(22) PCT Filed: Apr. 26, 2010
(86) PCT No.: PCT/JP2010/002975

§ 371 Date: Sep. 19, 2011

(30) Foreign Application Priority Data
May 14, 2009 (JP) 2009-117224

(51) Int. Cl. H01R 11/00

(52) U.S. Cl. 439/502

(57) ABSTRACT

A serial-parallel conversion circuit provided on one end of a cable body converts a first serial signal into parallel signals and outputs the parallel signals to parallel signal lines. A parallel-serial conversion circuit provided on another end of the cable body converts the parallel signals inputted from the parallel signal lines into a second serial signal and outputs the second serial signal to outside.

### RELATED APPLICATIONS

This application is the U.S. National Phase under 35 U.S.C. §371 of International Application No. PCT/JP2010/002975, filed on Apr. 26, 2010, which in turn claims the benefit of Japanese Application No. 2009-117224, filed on May 14, 2009, the disclosures of which Applications are incorporated by reference herein.

### FIELD OF THE INVENTION

The present invention relates to a communication cable which enables fast signal transmission.

### BACKGROUND OF THE INVENTION

In recent years, digital interfaces used for signal transmission in a device or between devices are increasingly advanced so that signals can be transmitted faster. Of the interfaces, parallel interfaces, through which signals are transmitted in parallel, fail more often to synchronize the signals as the signal transmission is faster, making it practically infeasible to transmit the signals at high speeds. To solve the problem, serial interfaces configured suitably for fast signal transmission, examples of which are HDMI (High-Definition Multimedia Interface) and USB (Universal Serial Bus), are penetrating into the market of electronic devices such as computer terminals and AV devices, contributing to higher transfer speeds of the transmitted signals. Such a high-speed signal transmission, however, results in more attenuation of the signals transmitted through a communication cable, and more radiation noise generated from the cable. Besides that, these interfaces configured for fast signal transmission are subject to predefined limits for shapes of a cable connector and a substrate connector, and number of terminals, and it is basically not possible to change the connector shapes or increases the terminals.

The techniques available so far for compensating for the signal attenuation in the communicable cable are to amplify the signals before they are transmitted using a pre-emphasis circuit embedded in a transmission-side LSI, and to improve attenuation characteristics in high frequency bands using an equalizing circuit embedded in a reception-side LSI or a cable plug. Although these techniques are available now, the signal transmission speed is expected to further increase in the future. As the technology further advance, therefore, the current techniques alone will not be able to compensate for the attenuation characteristics in high frequency bands of the communication cable.

The Patent Document 1 discloses the invention wherein a parallel-serial conversion circuit and an electro-optic conversion circuit are provided on one end of a waveguide formed in a flexible cable, and an optic-electro conversion circuit and a serial-parallel conversion circuit are provided on the other end of the waveguide so that signals are optically transmitted through the flexible cable. The disclosed invention employs the optical signal transmission with less attenuation in high frequency bands, thereby pursuing increase of a serial signal transmission speed and reduction of a radiation noise generated from the cable.

### Prior Art Document

### Patent Document

Patent Document 1: Japanese Translation of PCT Application No. 2007-536563

### SUMMARY OF THE INVENTION

### Problem To Be Solved by the Invention

The invention disclosed in the Patent Document 1, wherein the electro-optic conversion circuit and the optic-electro conversion circuit are indispensable structural elements, increases power consumption in the cable.

The present invention provides a communication cable which enables fast signal transmission with less radiation noise, and a plug used in the communication cable.

### Means for Solving the Problem

A communication cable according to a second aspect of the present invention comprises:
a cable body having parallel signal lines;
a first plug provided on one end of the cable body to connect one end of the parallel signal lines to outside;
a second plug provided on another end of the cable body to connect another end of the parallel signal lines to outside;
a serial-parallel conversion circuit provided in the first plug to convert a first serial signal inputted from outside to the first plug into parallel signals and output the parallel signals to the parallel signal lines; and
a parallel-serial conversion circuit provided in the second plug to convert the parallel signals inputted from the parallel signal lines to the second plug into a second serial signal and output the second serial signal to outside, wherein
first delay lines respectively having different delay amounts are respectively connected to input terminals of a plurality of signal lines constituting the parallel signal line, and the serial-parallel conversion circuit thereby generates the parallel signals so that the parallel signals respectively have different output timings; and second delay lines respectively having different delay amounts are respectively connected to output terminals of the signal lines, and the serial-parallel conversion circuit thereby equalizes the delay amounts of the first delay lines and delay amounts of the second delay lines which are summed in the respective signal lines in all of the signal lines.

In the communication cable thus technically characterized, the first serial signal is converted into the parallel signals by the serial-parallel conversion circuit and then transmitted through the cable body. Therefore, the transmission speed of each parallel signals transmitted through the cable body can be lowered as compared to that of the first serial signal although the signal transmission speeds of the signals on the whole remain unchanged. The present invention thus technically advantageous can reduce a level of attenuation of the signals transmitted through the cable body without slowing down the transmission speed of the communication cable per se. Further, the signal transmitted through the cable has a lower frequency because of the lower signal transmission speed. It is known that a noise radiated from a signal line varies in proportion to the square of a signal frequency. Therefore, the present invention, wherein the frequency of the signal transmitted through the cable is lowered, can successfully lessen a radiation noise. Further, the communication cable thus technically characterized advances or delays the signal transition timings of the parallel signals relative to each other, thereby reducing an amount of noise radiated from the cable body as compared to simultaneous signal transitions. Further, the second delay lines are respectively connected to the output terminals of the signal lines. The delay amounts of the first delay lines and delay amounts of the second delay lines are summed in the respective signal lines, and the summed values thereby obtained are equal in all of the signal lines. Then, input timings of any data inputted from the signal lines to the parallel-serial conversion circuit can be all equalized. This helps to sustain a high level of accuracy in the conversion by the parallel-serial conversion circuit without additionally providing a circuit for timing adjustment.

According to a preferred mode of the present invention, the first and second serial signals are both serial differential signals, and the parallel signals are parallel differential signals.

The communication cable thus technically characterized can be used as a communication cable having an interface configured for differential signal transmission. Further, the communication cable can lessen more radiation noise generated from the cable body.

According to another preferred mode of the present invention, the first and second serial signals are both serial single-end signals, and the parallel signals are parallel differential signals.

The preferred mode, wherein the parallel differential signals are transmitted through the cable body, can lessen more radiation noise generated from the cable body.

According to still another preferred mode of the present invention, the first serial signal is a serial differential signal, the parallel signals are parallel single-end signals, and the second serial signal is a serial differential signal.

The preferred mode, wherein the parallel single-end signals are transmitted through the cable body, can decrease number of the signal lines as compared to any mode in which the parallel differential signals are transmitted therethrough, thereby diametrically reducing the cable.

According to still another preferred mode of the present invention, the serial-parallel conversion circuit generates the parallel signals so that the parallel signals have amplitudes smaller than an amplitude of the first serial signal.

The preferred mode, wherein the signal is transmitted through the cable body at a low transmission speed and the signal has a small amplitude, can lessen more radiation noise generated from the cable body. In the case where the serial-parallel conversion circuit is voltage-driven, a drive voltage of the serial-parallel conversion circuit is lowered so that the parallel signals have smaller amplitudes than the second serial signal. In the case where the serial-parallel conversion circuit is current-driven, a drive current of the serial-parallel conversion circuit is lowered so that the parallel signals have smaller amplitudes than the second serial signal.

According to still another preferred mode of the present invention, the serial-parallel conversion circuit generates the parallel signals so that signal transition times of the parallel signals are longer than a signal transition time of the first serial signal.

The preferred mode, wherein more time is used for the parallel signal transition (times for the signals to rise, times for the signals to fall), can further down-convert a frequency component included in the signals, leading to further reduction of the signal attenuation and radiation noise. To provide the communication cable thus technically characterized, an output drive circuit in the serial-parallel conversion circuit is arranged to have a lower current capacity than in the parallel-serial conversion circuit, or a low-pass filter is provided in an output terminal of the serial-parallel conversion circuit.

According to still another preferred mode of the present invention, at least one of a signal output unit of the serial-parallel conversion circuit and a signal input unit of the parallel-serial conversion circuit is provided with a common mode control circuit.

The preferred mode, wherein the common mode control circuit improves the skew of the differential signal, can lessen the radiation of a common mode noise from the cable body. As a result, a possible malfunction of any circuit resulting from an incoming large common mode component can be prevented from happening.

According to still another preferred mode of the present invention, at least one of a signal input unit of the serial-parallel conversion circuit and a signal output unit of the parallel-serial conversion circuit is provided with a common mode control circuit.

The preferred mode, wherein the common mode control circuit improves the intra-skew of the differential signal, can prevent the occurrence of a possible malfunction of any circuit in and out of the cable resulting from an incoming large common mode component.

According to still another preferred mode of the present invention, at least one of a signal input unit of the serial-parallel conversion circuit and a signal output unit of the parallel-serial conversion circuit is provided with an ESD protection circuit.

In the event of ESD (Electrostatic Discharge) when terminals of the first and second plugs are contacted by someone, the ESD protection circuit according to the preferred mode can block any signals having a large instantaneous voltage from entering internal circuits of the first and second plugs, thereby improving the ESD resistance of the cable.

According to still another preferred mode of the present invention, a signal output unit of the serial-parallel conversion circuit is provided with an emphasis circuit.

According to the preferred mode, the amplification of the parallel signals by the emphasis circuit can compensate for any increase of the signals attenuation when the signals lines of the cable body are diametrically reduced. As a result, the cable can be diametrically downsized.

According to still another preferred mode of the present invention, a signal input unit of the parallel-serial conversion circuit is provided with an equalizing circuit.

According to the preferred mode, the equalization of the parallel signals by the equalizing circuit can compensate for any increase of the signal attenuation when the signals lines of the cable body are diametrically reduced. As a result, the cable can be diametrically downsized.

### Effect of the Invention

According to the communication cable provided by the present invention wherein the serial signal is converted into the parallel signals by the serial-parallel conversion circuit and then transmitted through the cable body, the transmission speed of the signal transmitted through the cable body is lowered. This lessens a level of attenuation of the signal transmitted through the cable body without dropping the transmission speed of the communication cable per se, thereby accelerating the signal transmission. Further, the frequency of the signal transmitted through the cable body is lowered, which controls the radiation noise generated from the signal line (in proportion to the square of the signal frequency). Though it is basically not possible to change the connector shapes or increases the terminals, the present invention can exert the operational effects described so far without changing the connector shapes or increasing number of terminals.

### BRIEF DESCRIPTION OF THE DRAWINGS

FIG. 1 is an illustration of a communication cable according to an exemplary embodiment 1 of the present invention.

FIG. 2 (a) is a waveform chart of a serial single-end signal.

FIG. 2 (b) is a waveform chart of parallel single-end signals.

FIG. 3 is an illustration of a communication cable according to an exemplary embodiment 2 of the present invention.

FIG. 4 (a) is a waveform chart of a serial differential signal.

FIG. 4 (b) is a waveform chart of a parallel differential signals.

FIG. 5 is an illustration of a communication cable according to an exemplary embodiment 3 of the present invention.

FIG. 6 is an illustration of a communication cable according to an exemplary embodiment 4 of the present invention.

FIG. 7 is a waveform chart of parallel single-end signals according to an exemplary embodiment 5 of the present invention.

FIG. 8A is a waveform chart of parallel single-end signals according to an exemplary embodiment 6 of the present invention.

FIG. 8B is an illustration of a communication cable according to an exemplary embodiment 6 of the present invention.

FIG. 9 (a) is a waveform chart of a serial single-end signal according to an exemplary embodiment 7 of the present invention.

FIG. 9 (b) is a waveform chart of parallel single-end signals according to the exemplary embodiment 7.

FIG. 10 is an illustration of a communication cable according to an exemplary embodiment 8 of the present invention.

FIG. 11 is an illustration of a communication cable according to an exemplary embodiment 9 of the present invention.

FIG. 12 is an illustration of a communication cable according to an exemplary embodiment 10 of the present invention.

FIG. 13 is an illustration of a communication cable according to an exemplary embodiment 11 of the present invention.

FIG. 14 is an illustration of a communication cable according to an exemplary embodiment 12 of the present invention.

### EXEMPLARY EMBODIMENTS FOR CARRYING OUT THE INVENTION

### Exemplary Embodiment 1

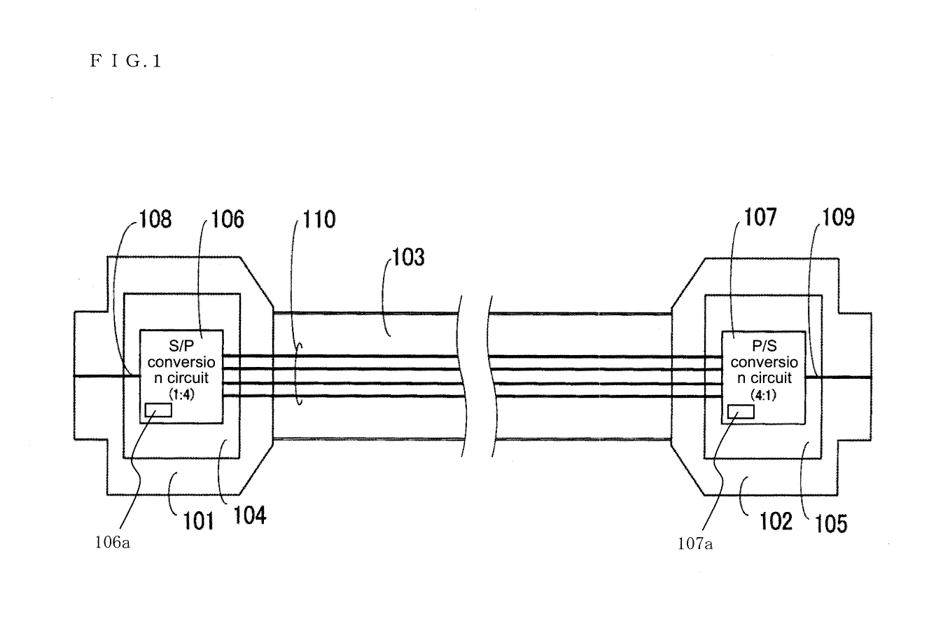

FIG. 1 is an illustration of a communication cable according to an exemplary embodiment 1 of the present invention. The communication cable according to the present exemplary embodiment has a first plug 101, a second plug 102, a cable body 103, a first internal substrate 104, a second internal substrate 105, a serial-parallel conversion circuit 106, a parallel-serial conversion circuit 107, a first serial single-end signal line 108, a second serial single-end signal line 109, and parallel single-end signal lines 110. The serial-parallel conversion circuit 106 and the parallel-serial conversion circuit 107 are both configured for 1:4 serial/parallel mutual conversions. The serial-parallel conversion circuit 106 and the parallel-serial conversion circuit 107 respectively have therein an output drive circuit 106a and an output drive circuit 107a. The output drive circuits 106a and 107a may be voltage-driven circuits or current-driven circuits.

The cable body 103 is a signal cable which connects the first plug 101 and the second plug 102 to each other. The first internal substrate 104 is provided in the first plug 101, and the second internal substrate 105 is provided in the second pug 102. The serial-parallel conversion circuit 106 is mounted on the first internal substrate 104, and the parallel-serial conversion circuit 107 is mounted on the second internal substrate 105. The first serial single-end signal line 108 is a signal line through which signals are transmitted from outside of the communication cable and inputted to the first plug 101. The first serial single-end signal line 108 is connected to an input terminal of the first plug 101. The second serial single-end signal line 109 connected to an output terminal of the second plug 102 so that signals transmitted through the communication cable (cable body 103) are outputted from the second plug 102. The parallel single-end signal lines 110 are provided in the cable body 103 to be used for signal transmission in the cable body 103.

The serial-parallel conversion circuit 106 converts a serial single-end signal (first serial signal) inputted from the first serial single-end signal line 108 into four parallel single-end signals and outputs the resulting signals to the parallel single-end signal lines 110. The parallel-serial conversion circuit 107 converts the four parallel single-end signals inputted from the parallel single-end signal lines 110 into a serial single-end signal (second serial signal) and outputs the resulting signal to the second serial single-end signal line 109.

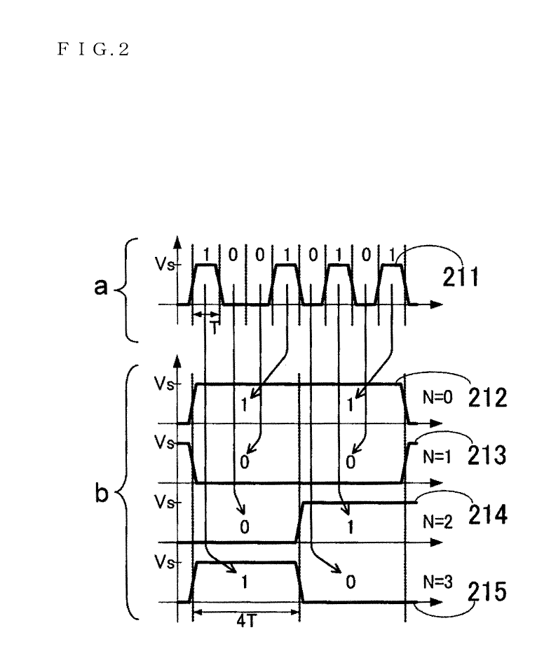

FIG. 2 (a) is an illustration of a waveform 211 of the serial single-end signal transmitted through the first, second serial single-end signal line 108, 109. FIG. 2 (b) is an illustration of waveforms 212, 213, 214, and 215 of the parallel single-end signals transmitted through the parallel single-end signal lines 110. A transmission speed of the parallel single-end signals transmitted through the parallel single-end signal lines 110 (generated by 1:4 serial/parallel mutual conversion) is ¼ of a transmission speed of the serial single-end signal transmitted through the first, second serial single-end signal line 108, 109. Therefore, when the transmission speed of the serial single-end signal transmitted through the first, second serial single-end signal line 108, 109 is increased, the transmission speed of the parallel single-end signals transmitted through the parallel single-end signal lines 110 are not very fast (¼ of the transmission speed of the serial single-end signal). This enables a very high signal transmission speed, while effectively controlling a level of attenuation of the signals in the cable body. As far as the transmission speed of the signal transmitted through the cable body 103 thus stays low, the signal transmitted through the cable body 103 has a low frequency. It is known that a noise radiated from a signal line varies in proportion to the square of a signal frequency. Therefore, the present exemplary embodiment can successfully reduce an amount of noise radiated from the signal lines.

Though the 1:4 serial/parallel mutual conversion is employed in the present exemplary embodiment, the serial/parallel mutual conversion may be performed in the proportion of 1:N or N:1 (N is a positive integral number). The intended use of the cable body 103 is not necessarily limited to a pair of serial-parallel and parallel-serial conversions. To flexibly respond to a plurality of pairs of serial-parallel and parallel-serial conversions, the cable body 103 may include a plurality of combinations of paired serial-parallel conversion circuits and parallel-serial conversion circuits, and signal lines respectively connected thereto. The cable body 103 may include therein other signal lines, for example, power line, control line, and clock line. The signal lines of the cable body 103 may be metal lines, coaxial lines, flexible cables, or shielded signal lines.

### Exemplary Embodiment 2

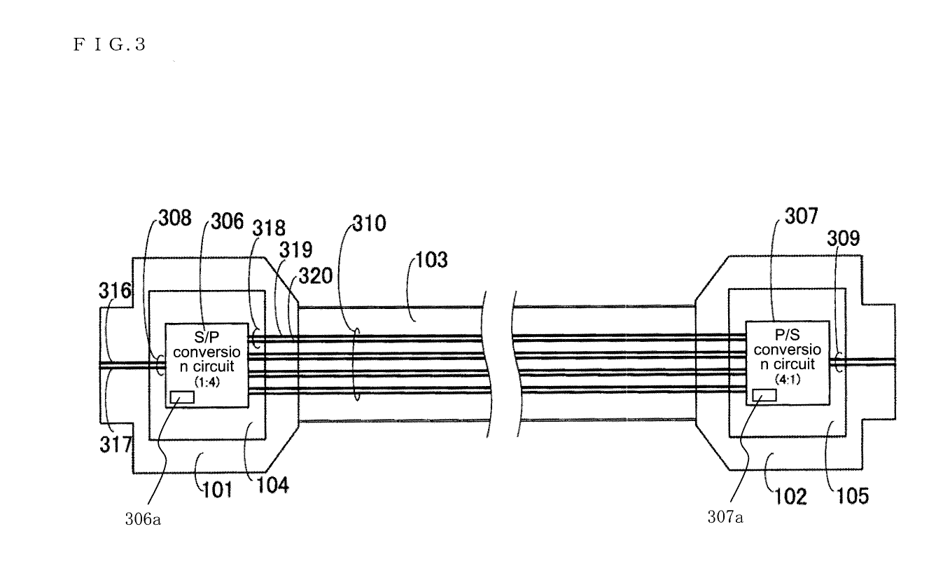

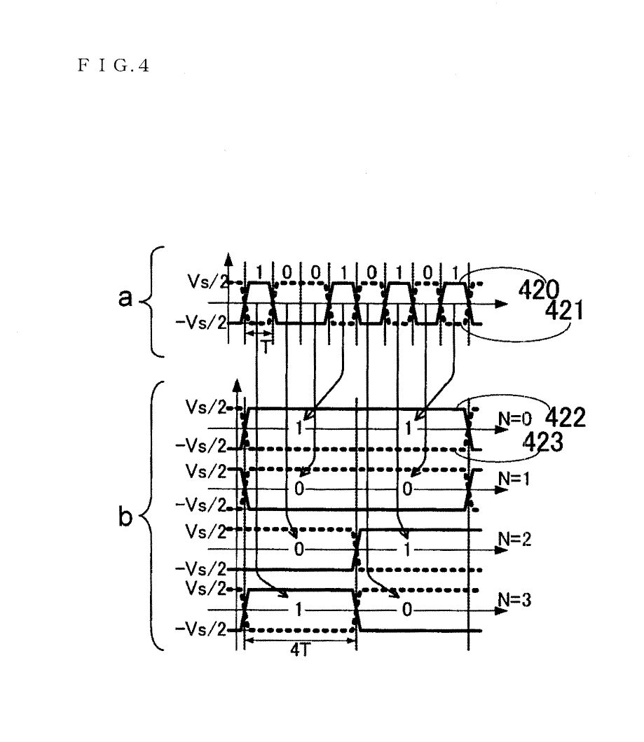

FIG. 3 is an illustration of a communication cable according to an exemplary embodiment 2 of the present invention. Any structural elements of FIG. 3 configured identically or similarly to those illustrated in FIG. 1 will not be described, with the same reference symbols simply attached thereto.

The communication cable according to the present exemplary embodiment has a serial-parallel conversion circuit 306 mounted on the first internal substrate 104, a parallel-serial conversion circuit 307 mounted on the second internal substrate 105, a first serial differential signal line 308 provided in the first plug 101, a second serial differential signal line 309 provided in the second plug 102, and parallel differential signal lines 310 provided in the cable body 103. The first and second serial differential signal lines 308 and 309 respectively include signal lines 316 and 317.

The serial-parallel conversion circuit 306 converts a pair of serial differential signals (first serial signal) inputted from the first serial differential signal line 308 into four pairs of parallel differential signals and outputs the resulting signals to the parallel differential signal lines 310. The parallel-serial conversion circuit 307 converts the four pairs of parallel differential signals inputted from the parallel differential signal lines 310 into a pair of serial differential signals (second serial signal) and outputs the resulting signals to the second serial differential signal line 309.

FIG. 4 (a) illustrates waveforms 420 and 421 of the serial differential signals transmitted through the first serial differential signal line 308 (signal lines 316 and 317). The waveform 420 is the waveform of a positive signal transmitted through the signal line 316, and the waveform 421 is the waveform of a negative signal transmitted through the signal line 317. FIG. 4 (b) illustrates waveforms 422 and 423 of the parallel differential signals transmitted through the parallel differential signal lines 310. The parallel differential signal lines 310 includes a plurality of differential signal line pairs 318. The differential signal line pairs 318 each includes a signal line 319 and a signal line 320. The waveform 422 is the waveform of a positive signal transmitted through each of the differential signal line pairs 318, and the waveform 423 is the waveform of a negative signal transmitted therethrough.

The parallel differential signals transmitted through the parallel differential signal lines 310 (generated by 1:4 serial/parallel mutual conversion) has a transmission speed equal to ¼ of a transmission speed of the serial differential signal transmitted through the first, second serial differential signal line 308, 309. Therefore, when the transmission speed of the serial differential signal transmitted through the first, second serial differential signal line 308, 309 is increased, the transmission speed of the parallel differential signal transmitted through the parallel differential signal lines 310 are not fast (¼ of the transmission speed of the serial differential signal). This enables a very high signal transmission speed, while effectively controlling a level of attenuation of the signals in the cable body. As far as the transmission speed of the signal transmitted through the cable body 103 thus stays low, the signal transmitted through the cable body 103 has a low frequency. It is known that a noise radiated from a signal line varies in proportion to the square of a signal frequency. Therefore, the present exemplary embodiment can successfully reduce an amount of noise radiated from the signal lines. Because a magnetic field canceling effect is exerted when a differential signal is transmitted, the present exemplary embodiment wherein the parallel differential signals are transmitted through the cable body 103 can further lessen the radiation noise generated from the cable body 103, and can also improve the removal of any noise entering the cable body 103 from outside. The communication cable according to the present exemplary embodiment thus technically characterized is particularly useful for any interfaces configured for differential transmission.

Though the 1:4 serial/parallel mutual conversion is employed in the present exemplary embodiment, the serial/parallel mutual conversion may be performed in the proportion of 1:N or N:1 (N is a positive integral number). The intended use of the cable body 103 is not necessarily limited to a pair of serial-parallel and parallel-serial conversions. To flexibly respond to a plurality of pairs of serial-parallel and parallel-serial conversions, the cable body 103 may include a plurality of combinations of paired serial-parallel conversion circuits and parallel-serial conversion circuits, and signal lines respectively connected thereto. The cable body 103 may include therein other signal lines, for example, power line, control line, and clock line. The signal lines of the cable body 103 may be metal lines, coaxial lines, parallel metal lines, stranded lines, flexible cables, or shielded signal lines.

### Exemplary Embodiment 3

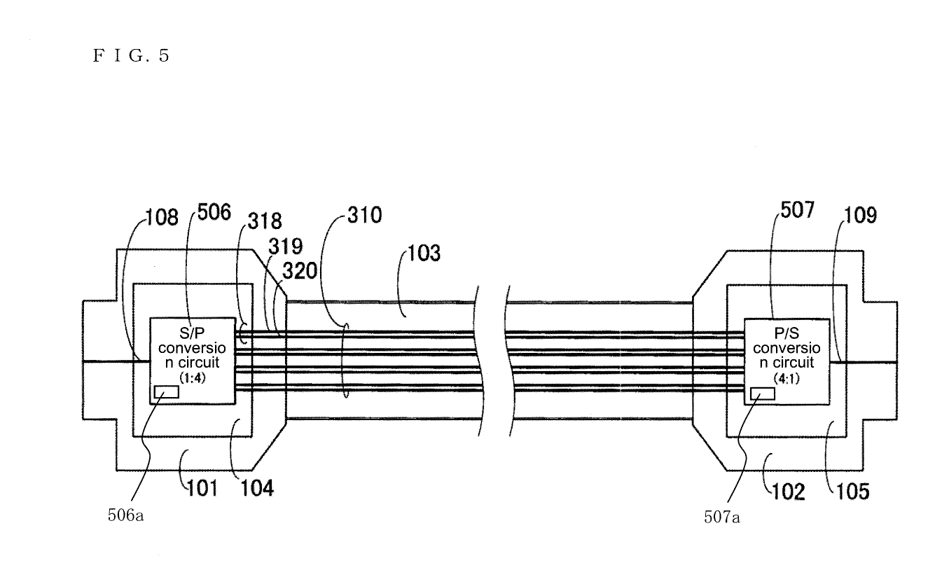

FIG. 5 is an illustration of a communication cable according to an exemplary embodiment 3 of the present invention. Any structural elements of FIG. 5 configured identically or similarly to those illustrated in FIGS. 1 and 3 will not be described, with the same reference symbols simply attached thereto.

The present exemplary embodiment is technically characterized in that a serial-parallel conversion circuit 506 and a parallel-serial conversion circuit 507 are provided. The serial-parallel conversion circuit 506 converts a serial single-end signal (first serial signal) inputted from the first serial single-end signal line 108 into four pairs of parallel differential signals and outputs the resulting signals to the parallel differential signal lines 310. The parallel-serial conversion circuit 507 converts the four pairs of parallel differential signals inputted from the parallel differential signal lines 310 into a serial single-end signal (second serial signal) and outputs the resulting signal to the second serial single-end signal line 109.

FIG. 2 (a) is an illustration of a waveform 211 of the serial single-end signal transmitted through the first, second serial single-end signal line 108, 109. FIG. 4 (b) is an illustration of waveforms 422 and 423 of the parallel differential signals transmitted through the parallel differential signal lines 310. The parallel differential signal lines 310 includes a plurality of differential signal line pairs 318. The differential signal line pairs 318 each includes a signal line 319 and a signal line 320. The waveform 422 is the waveform of a positive signal transmitted through each of the differential signal line pairs 318, and the waveform 423 is the waveform of a negative signal transmitted therethrough.

The parallel differential signal transmitted through the parallel differential signal lines 310 (generated by 1:4 serial/parallel mutual conversion) have a transmission speed equal to ¼ of a transmission speed of the serial differential signal transmitted through the first, second serial single-end signal line 108, 109. Therefore, when the transmission speed of the serial single-end signal transmitted through the first, second serial single-end signal line 108, 109 is increased, the transmission speed of the parallel differential signal transmitted through the parallel differential signal lines 310 are not very fast (¼ of the transmission speed of the serial single-end signal). This enables a very high signal transmission speed, while effectively controlling a level of attenuation of the signals in the cable body. As far as the transmission speed of the signal transmitted through the cable body 103 thus stays low, the signal transmitted through the cable body 103 has a low frequency. It is known that a noise radiated from a signal line varies in proportion to the square of a signal frequency. Therefore, the present exemplary embodiment can successfully reduce an amount of noise radiated from the signal lines. Because a magnetic field canceling effect is exerted when a differential signal is transmitted, the present exemplary embodiment wherein the parallel differential signals are transmitted through the cable body 103 can further lessen the radiation noise generated from the cable body 103, and can also improve the removal of any noise entering the cable body 103 from outside.

Though the 1:4 serial/parallel mutual conversion is employed in the present exemplary embodiment, the serial/parallel mutual conversion may be performed in the proportion of 1:N or N:1 (N is a positive integral number). The intended use of the cable body 103 is not necessarily limited to a pair of serial-parallel and parallel-serial conversions. To flexibly respond to a plurality of pairs of serial-parallel and parallel-serial conversions, the cable body 103 may include a plurality of combinations of paired serial-parallel conversion circuits and parallel-serial conversion circuits, and signal lines respectively connected thereto. The cable body 103 may include therein other signal lines, for example, power line, control line, and clock line. The signal lines of the cable body 103 may be metal lines, coaxial lines, parallel metal lines, stranded lines, flexible cables, or shielded signal lines.

### Exemplary Embodiment 4

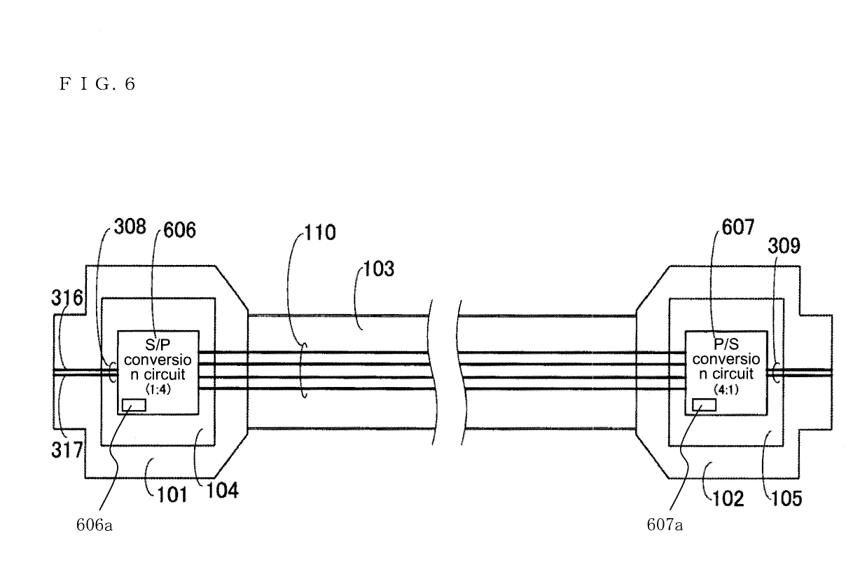

FIG. 6 is an illustration of a communication cable according to an exemplary embodiment 4 of the present invention. Any structural elements of FIG. 6 configured identically or similarly to those illustrated in FIGS. 1 and 3 will not be described, with the same reference symbols simply attached thereto.

The present exemplary embodiment is technically characterized in that a serial-parallel conversion circuit 606 and a parallel-serial conversion circuit 607 are provided. The serial-parallel conversion circuit 606 converts a pair of serial differential signal (first serial signal) inputted from the first serial differential signal line 308 into four pairs of parallel single-end signals and outputs the resulting signals to the parallel single-end signal lines 110. The parallel-serial conversion circuit 607 converts the four pairs of parallel single-end signals inputted from the parallel single-end signal lines 110 into a pair of serial differential signals (second serial signal) and outputs the resulting signals to the second serial differential signal line 309. The first and second serial differential signal lines 308 and 309 respectively include a signal line 316 and a signal line 317.

FIG. 4 (a) is an illustration of waveforms 420 and 421 of the serial differential signals transmitted through the first serial differential signal line 308 (signal lines 316 and 317). The waveform 420 is the waveform of a positive signal transmitted through the signal line 316, and the waveform 421 is the waveform of a negative signal transmitted through the signal line 317. FIG. 2 (b) is an illustration of waveforms 212, 213, 214, and 215 of the parallel single-end signals transmitted through the parallel single-end signal lines 110. The parallel single-end signals transmitted through the parallel single-end signal lines 110 (generated by 1:4 serial/parallel mutual conversion) have a transmission speed equal to ¼ of a transmission speed of the serial differential signal transmitted through the first, second serial differential signal line 308, 309. Therefore, when the transmission speed of the serial differential signal transmitted through the first, second serial differential signal line 308, 309 is increased, the transmission speed of the parallel single-end signals transmitted through the parallel single-end signal lines 110 are not very fast (¼ of the transmission speed of the serial differential signal). This enables a very high signal transmission speed, while effectively controlling a level of attenuation of the signals in the cable body. As far as the transmission speed of the signal transmitted through the cable body 103 thus stays low, the signal transmitted through the cable body 103 has a low frequency. It is known that a noise radiated from a signal line varies in proportion to the square of a signal frequency. Therefore, the present exemplary embodiment can successfully reduce an amount of noise radiated from the signal lines.

The communication cable according to the present exemplary embodiment thus technically characterized is particularly useful for any interfaces configured for differential transmission. Further, the communication cable requiring less signal lines because the parallel single-end signals are transmitted through the cable body 103 can be diametrically reduced.

Though the 1:4 serial/parallel mutual conversion is employed in the present exemplary embodiment, the serial/parallel mutual conversion may be performed in the proportion of 1:N or N:1 (N is a positive integral number). The intended use of the cable body 103 is not necessarily limited to a pair of serial-parallel and parallel-serial conversions. To flexibly respond to a plurality of pairs of serial-parallel and parallel-serial conversions, the cable body 103 may include a plurality of combinations of paired serial-parallel conversion circuits and parallel-serial conversion circuits, and signal lines respectively connected thereto. The cable body 103 may include therein other signal lines, for example, power line, control line, and clock line. The signal lines of the cable body 103 may be metal lines, coaxial lines, parallel metal lines, stranded lines, flexible cables, or shielded signal lines.

### Exemplary Embodiment 5

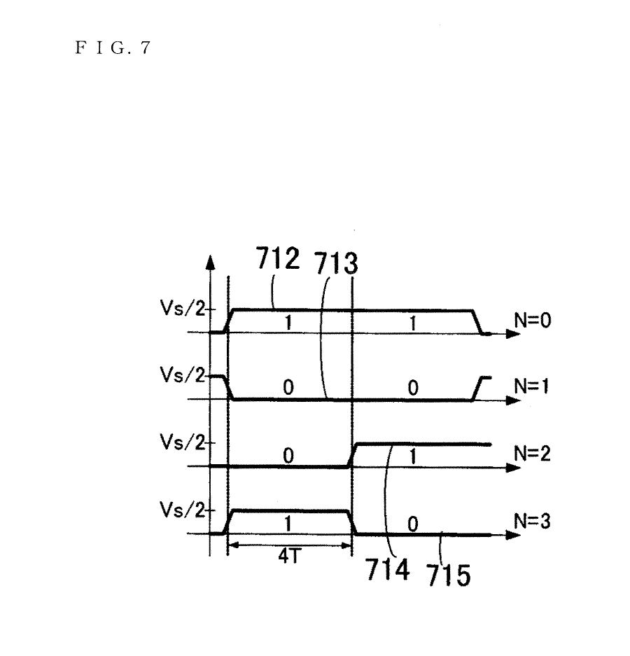

FIG. 7 is a waveform chart of parallel single-end signals according to an exemplary embodiment 5 of the present invention. Though the present exemplary embodiment provides such a technical feature that is similar to the exemplary embodiment 1, the serial-parallel conversion circuit 106 performs a signal conversion slightly different to that of the exemplary embodiment 1. Hereinafter, the serial-parallel conversion circuit according to the present exemplary embodiment is called a serial-parallel conversion circuit 106₍₅₎. The serial-parallel conversion circuit 106₍₅₎ converts a serial single-end signal inputted from the first serial single-end signal line 108 (first serial signal) into four parallel single-end signals (FIG. 7 illustrates waveforms 712, 713, 714, and 715 of the four parallel single-end signals). A difference to the exemplary embodiment 1 is that the parallel single-end signals have a level of amplitude equal to a half of a level of amplitude of the serial single-end signal according to the exemplary embodiment 1 illustrated in FIG. 2 (a) (FIG. 2 illustrates waveforms 212, 213, 214, and 215 of the four parallel single-end signals).

The amplitude adjustment is more specifically described below. As described earlier, the output drive circuit 106a of the serial-parallel conversion circuit 106 may be voltage-driven or current-driven. In the case where the voltage-driven output drive circuit 106a is used, a drive voltage of the serial-parallel conversion circuit 106 is adjusted by adjusting a power supply voltage of the voltage-driven output drive circuit 106a, so that the amplitude adjustment can be performed. More specifically, a regulator circuit additionally provided, for example, is used to continuously lower the drive voltage of the output drive circuit 106a until the amplitude of the parallel single-end signals falls below the amplitude of the serial single-end signal. In the case where the current-driven output drive circuit 106a is used, a drive current of the serial-parallel conversion circuit 106 is adjusted by adjusting an amount of current from a current source thereof, so that the amplitude adjustment can be performed. More specifically, a low current power source additionally provided, for example, is used to continuously lower the drive current of the output drive circuit 106a until the amplitude of the parallel single-end signals falls below the amplitude of the serial single-end signal.

According to the exemplary embodiment 1 or the exemplary embodiment 5, when the transmission speed of the serial single-end signal transmitted through the first, second serial single-end signal line 108, 109 is increased, the transmission speed of the parallel single-end signals transmitted through the parallel single-end signal lines 110 is still lower than the transmission speed of the serial single-end signal (¼). This reduces a level of attenuation of the signals in the cable body 103, and the signal attenuation thus reduced results in a smaller amplitude of the parallel single-end signals. The signal amplitude thus reduced results in less radiation noise from the cable body 103. In the parallel-serial conversion circuit 107₍₅₎ according to the present exemplary embodiment, the amplitude of the serial single-end signal (second serial signal) is increased to be equal to twice of the amplitude of the parallel-serial signal so that the amplitude of the serial single-end signal (second serial signal) is equal to the amplitude of the serial single-end signal (first serial signal). The first serial signal and the second serial signal are thus equalized so that signal transmission conditions remain unchanged.

According to the present exemplary embodiment, the amplitude of the parallel single-end signals are ½ of the amplitude of the serial single-end signal. However, the present exemplary embodiment can accomplish the described operational effect as far as the amplitude of the parallel single-end signals are smaller than the amplitude of the serial single-end signal. In the description of the present exemplary embodiment, the parallel single-end signals are converted into the serial single-end signal (similarly to the exemplary embodiment 1). The present exemplary embodiment is applicable to the signal conversions according to the other exemplary embodiments (for example, conversion of the parallel differential signals into the serial differential signal).

### Exemplary Embodiment 6

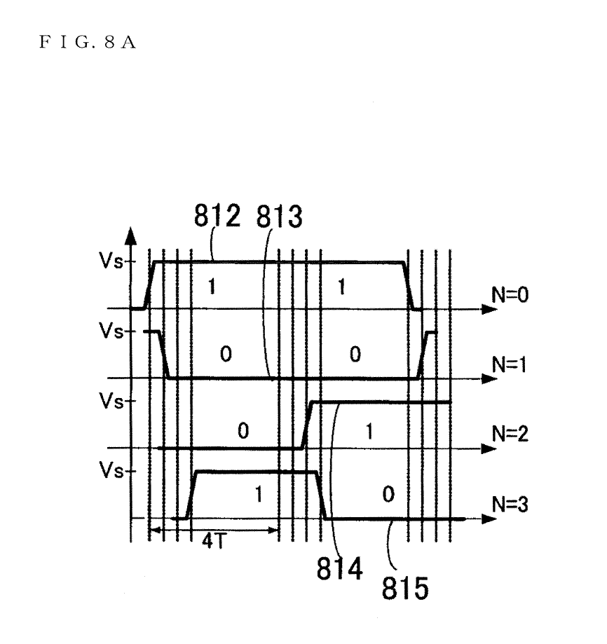

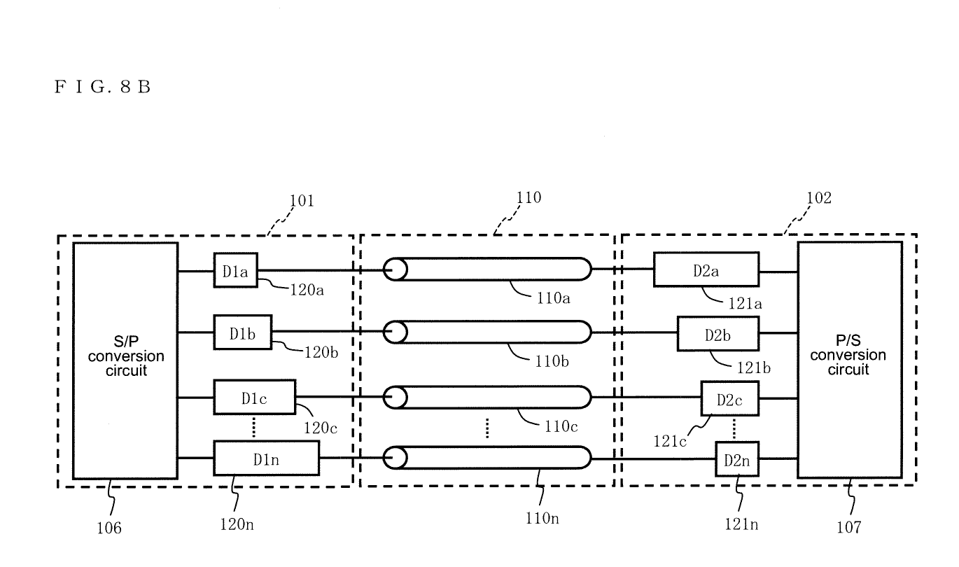

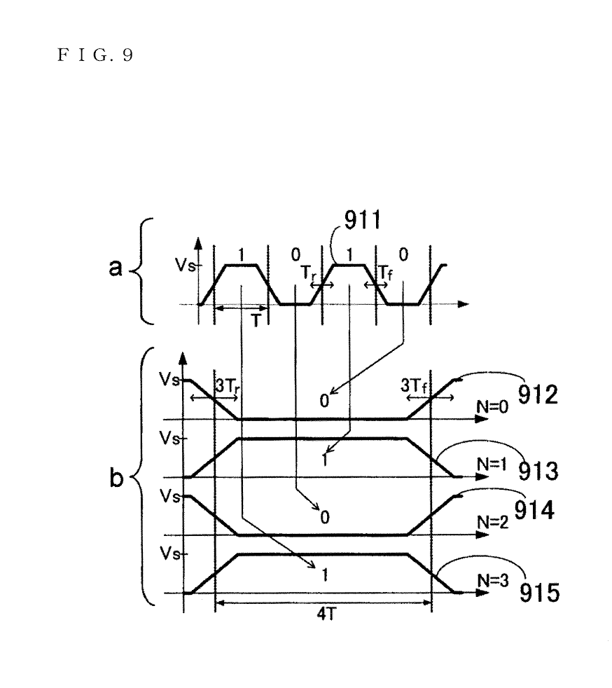

FIG. 8A is a waveform chart of parallel single-end signals according to an exemplary embodiment 6 of the present invention. Though the present exemplary embodiment provides such a technical feature that is similar to the exemplary embodiment 1, the serial-parallel conversion circuit 106 performs a signal conversion slightly different to that of the exemplary embodiment 1. Hereinafter, the serial-parallel conversion circuit according to the present exemplary embodiment is called a serial-parallel conversion circuit 106₍₆₎. The serial-parallel conversion circuit 106₍₆₎ converts a serial single-end signal inputted from the first serial single-end signal line 108 (first serial signal) into four parallel single-end signals (FIG. 8 illustrates waveforms 812, 813, 814, and 815 of the four parallel single-end signals). A difference to the exemplary embodiment 1 is that an output timing of the parallel single-end signals are different to an output timing of the serial single-end signal according to the exemplary embodiment 1 illustrated in FIG. 2 (a) (FIG. 2 illustrates waveforms 212, 213, 214, and 215 of the serial single-end signals).

Conventionally, an amount of noise emitted from the signal lines varies in proportion to the square of a signal frequency. Therefore, a radiation noise generated from a signal line increase as the frequency of a signal transmitted through the signal line is higher. A signal includes a large amount of high-frequency components in a signal transition section thereof. The present exemplary embodiment advances or delays the signal transition timings of the parallel single-end signals relative to each other, thereby reducing an amount of noise emitted from the signal lines as compared to simultaneous signal transitions. The parallel signals according to the present exemplary embodiment are parallel single-end signals (similarly to the exemplary embodiment 1). The present exemplary embodiment is applicable to the technical characteristics according to the other exemplary embodiments in which the parallel signals are parallel differential signals.

To advance or delay the signal output timings (transition timings) relative to each other, first delay lines 120a-120n respectively having different delay amounts are preferably further provided in input terminals of signal lines 110a-110n (n is an arbitrary natural number) constituting the parallel single-end signal lines 110 as illustrated in FIG. 8B. More preferably, second delay lines 121a-121n are further provided in output terminals of the signal lines 110a-110n as illustrated in FIG. 8B, and summed values of the delay amounts in the signal lines 110a-110n (delay amounts D1a-D1n of the first delay lines 120a-120n and delay amounts D2a-D2n of the second delay lines 121a-121n are summed, and the summed values thus obtained are D1a+D2a, D1b+D2b, . . . , D1n+D2N) are equal in all of the signal lines 110a-110n; D1a+D2a=D1b+D2b= . . . , =D1n+D2n. Then, input timings of any data inputted from the signal lines 110a-110n to the parallel-serial conversion circuit 107 are all equal irrespective of the different transition timings of the data being transmitted through the parallel single-end signal lines 110. This helps to sustain a high level of accuracy in the conversion by the parallel-serial conversion circuit 107 without additionally providing a circuit for timing adjustment.

The first and second delay lines 120a-120n and 121a-121n are preferably embedded in the serial-parallel conversion circuit 106, or parallel-serial conversion circuit 107, or substrates.

### Exemplary Embodiment 7

FIG. 9 is waveform charts of parallel single-end signals according to an exemplary embodiment 7 of the present invention. Though the present exemplary embodiment provides such a technical feature that is similar to the exemplary embodiment 1, the serial-parallel conversion circuit 106 performs a signal conversion a slightly different to that of the exemplary embodiment 1. Hereinafter, the serial-parallel conversion circuit according to the present exemplary embodiment is called a serial-parallel conversion circuit 106₍₇₎. The serial-parallel conversion circuit 106₍₇₎ converts a serial single-end signal inputted from the first serial single-end signal line 108 (first serial signal; FIG. 9 illustrates a waveform 911 of the serial single-end signal) into four parallel single-end signals (FIG. 9 illustrates waveforms 912, 913, 914, and 915 of the four parallel single-end signals). A difference to the exemplary embodiment 1 is that time for the parallel single-end signals to rise and fall (signal transition time) is longer (three times longer in the present exemplary embodiment) than time for the serial single-end signal to rise and fall (signal transition time).

The signal transition time is thus adjusted by first and second methods described below. The first method sets a current capacity of the output drive circuit 106a provided in the serial-parallel conversion circuit 106 to be lower than a current capacity of the output drive circuit 107a provided in the parallel-serial conversion circuit 107 because there is correlation between the current capability of the output drive circuit 106a, 107a and the transition time of the conversion output of the conversion circuit 106, 107, and the transition time is longer as the current capability is lower. The second method additionally provides a low-pass filter (LPF) having a capacitance in an output terminal of the serial-parallel conversion circuit 106 because an output signal (parallel signals) of the conversion circuit 106, 107 which transmitted through the low-pass filter (LPF) needs more transition time.

When the times for the parallel single-end signals 912, 913, 914, and 915 to rise and fall are thus arranged to be longer, the frequency components included in the signals can be further lowered. As a result, the signal attenuation and radiation noise can be further reduced. The parallel signals in the description of the present exemplary embodiment is a single-end signal, however, may be a differential signal.

### Exemplary Embodiment 8

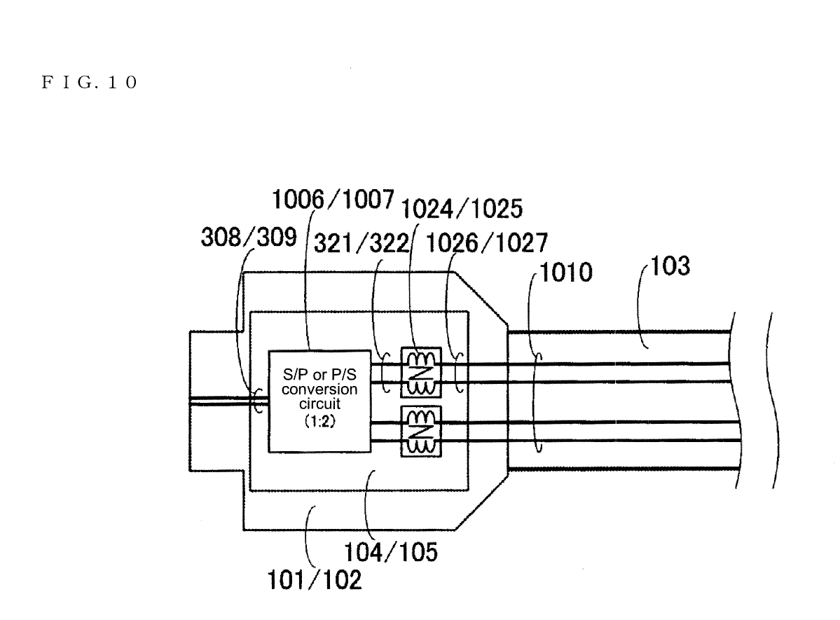

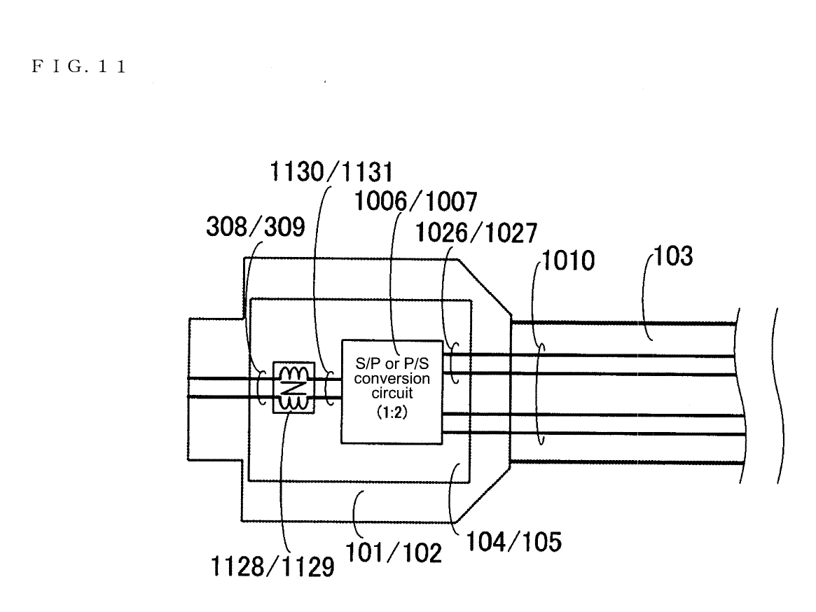

FIG. 10 is an illustration of first and second plugs 101 and 102 according to an exemplary embodiment 8 of the present invention. Any structural elements of FIG. 10 configured identically or similarly to those illustrated in FIGS. 1 and 3 will not be described, with the same reference symbols simply attached thereto. The serial-parallel conversion circuits provided in the present exemplary embodiment are a serial-parallel conversion circuit 1006 and a parallel-serial conversion circuit 107 configured for 1:2 serial/parallel mutual conversion. Because the serial-parallel conversion circuit 1006 and the parallel-serial conversion circuit 107 configured for 1:2 serial/parallel mutual conversion are provided, parallel differential signal lines 1010 provided in the cable body 103 has two differential signal line pairs 1026. However, the present exemplary embodiment is not necessarily limited thereto. The operational effect of the present exemplary embodiment can be similarly obtained when the serial-parallel conversion circuit 306 and the parallel-serial conversion circuit 307 (configured for 1:4 serial/parallel mutual conversion) are provided.

The present exemplary embodiment is technically characterized in that the first and second internal substrate 104 and 105 are respectively provided with common mode filters 1024 and 1025 which are examples of a common mode control circuit. The common mode filter 1024 is provided in a signal output unit of the serial-parallel conversion circuit 1006, which is an intermediate position between the serial-parallel conversion circuit 1006 and the cable body 103. The common mode filter 1024 filters a parallel differential signal inputted from the serial-parallel conversion circuit 1006 and outputs the filtered signal to the parallel differential signal lines 1010. The common mode filter 1025 is provided in a signal input unit of the parallel-serial conversion circuit 1007, which is an intermediate position between the parallel-serial conversion circuit 1007 and the cable body 103. The common mode filter 1025 filters parallel differential signals inputted from the parallel differential signal lines 1010 and outputs the filtered signal to the parallel-serial conversion circuit 1007. A reference numeral 321 illustrated in the drawing is a differential signal line pair which connects the common mode filter 1024 to the serial-parallel conversion circuit 1006, and a reference numeral 322 is a differential signal line pair which connects the common mode filter 1025 to the parallel-serial conversion circuit 1007. A reference numeral 1026 illustrated in the drawing is a differential signal line pair which connects the common mode filter 1024 to the parallel differential signal lines 1010, and a numeral 1027 illustrated in the drawing is a differential signal line pair which connects the common mode filter 1025 to the parallel differential signal lines 1010.

The present exemplary embodiment, wherein the parallel differential signals outputted from the serial-parallel conversion circuit 1006 passes through the common mode filter 1024, improves the intra-skew of the differential signal transmitted through the differential signal line pair 1026, thereby reducing common mode components. Therefore, a common mode radiation from the cable body 103 can be lessened. Further, the present exemplary embodiment can remove common mode components generated in the differential signal line pair 1026 of the cable body 103 by an external noise using the common mode filter 1025, thereby avoiding possible malfunctions of the circuits caused by large common mode components entering therein.

The present exemplary embodiment provides the common mode filters 1024 and 1025 respectively in the signal output unit of the serial-parallel conversion circuit 1006 and the signal input unit of the parallel-serial conversion circuit 1007, however, may provide these filters in one of them. Though the 1:2 serial/parallel mutual conversion is employed in the present exemplary embodiment, the serial/parallel mutual conversion may be performed in the proportion of 1:N or N:1 (N is a positive integral number). The present exemplary embodiment uses the common mode filters as examples of the common mode control circuit, however, may use ferrite cores as examples of the common mode control circuit. The communicable cable according to the present invention is not necessarily limited to a pair of serial-parallel and parallel-serial conversions. To flexibly respond to a plurality of pairs of serial-parallel and parallel-serial conversions, the cable body 103 may include a plurality of combinations of paired serial-parallel conversion circuits and parallel-serial conversion circuits, a plurality of pairs of common mode filters, and signal lines respectively connected thereto. The cable body 103 may include therein other signal lines, for example, power line, control line, and clock line. The signal lines of the cable body 103 may be metal lines, coaxial lines, parallel metal lines, stranded lines, flexible cables, or shielded signal lines.

### Exemplary Embodiment 9

FIG. 11 is an illustration of first and second plugs 101 and 102 according to an exemplary embodiment 9 of the present invention. Any structural elements of FIG. 11 configured identically or similarly to those illustrated in FIGS. 1 and 3 will not be described, with the same reference symbols simply attached thereto. The serial/parallel and parallel/serial conversion circuits according to the present exemplary embodiment are a serial-parallel conversion circuit 1006 and a parallel-serial conversion circuit 1007 configured for 1:2 serial/parallel mutual conversion, however, the present exemplary embodiment is not necessarily limited thereto. Because the serial-parallel conversion circuit 1006 and the parallel-serial conversion circuit 1007 configured for 1:2 serial/parallel mutual conversion are provided, a parallel differential signal lines 1010 provided in the cable body 103 is provided with two differential signal line pairs 1026. The present exemplary embodiment is applicable to the communication cable provided with the serial-parallel conversion circuit 306 and the parallel-serial conversion circuit 307 (configured for 1:4 serial/parallel mutual conversion).

The present exemplary embodiment is technically characterized in that the first and second internal substrate 104 and 105 are respectively provided with common mode filters 1128 and 1129, which are examples of a common mode control circuit. The common mode filter 1128 is provided in a signal input unit of the serial-parallel conversion circuit 1006, which is an intermediate position between the serial-parallel conversion circuit 1006 and the first serial differential signal line 308. The common mode filter 1028 filters a serial differential signal inputted from the first serial differential signal line 308 and outputs the filtered signal to the serial-parallel conversion circuit 1006. The common mode filter 1129 is provided in a signal output unit of the parallel-serial conversion circuit 1007, which is an intermediate position between the parallel-serial conversion circuit 1007 and the second serial differential signal line 309. The common mode filter 1129 filters a serial differential signal inputted from the parallel-serial conversion circuit 1007 and outputs the filtered signal to the second serial differential signal line 309. A reference numeral 1130 illustrated in the drawing is a differential signal line pair which connects the common mode filter 1128 to the serial-parallel conversion circuit 1006, and a reference numeral 1131 is a differential signal line pair which connects the common mode filter 1129 to the parallel-serial conversion circuit 1007.

The present exemplary embodiment, wherein the serial differential signal outputted from the first serial differential signal line 308 to the serial-parallel conversion circuit 1006 passes through the common mode filter 1128, improves the intra-skew of the differential signal transmitted through the differential signal line 1130, thereby reducing common mode components. Further, the present exemplary embodiment can remove common mode components by improving the intra-skew of the serial differential signal outputted from the parallel-serial conversion circuit 1007, thereby avoiding possible malfunctions of the circuits caused by large common mode components entering therein.

Though the 1:2 serial/parallel mutual conversion is employed in the present exemplary embodiment, the serial/parallel mutual conversion may be performed in the proportion of 1:N or N:1 (N is a positive integral number). The present exemplary embodiment uses the common mode filters as examples of the common mode control circuit, however, may use ferrite cores as examples of the common mode control circuit. The communicable cable according to the present invention is not necessarily limited to a pair of serial-parallel and parallel-serial conversions. To flexibly respond to a plurality of pairs of serial-parallel and parallel-serial conversions, the cable body 103 may include a plurality of combinations of paired serial-parallel conversion circuits and parallel-serial conversion circuits, a plurality of pairs of common mode filters, and signal lines respectively connected thereto. The cable body 103 may include therein other signal lines, for example, power line, control line, and clock line. The signal lines of the cable body 103 may be metal lines, coaxial lines, parallel metal lines, stranded lines, flexible cables, or shielded signal lines.

### Exemplary Embodiment 10

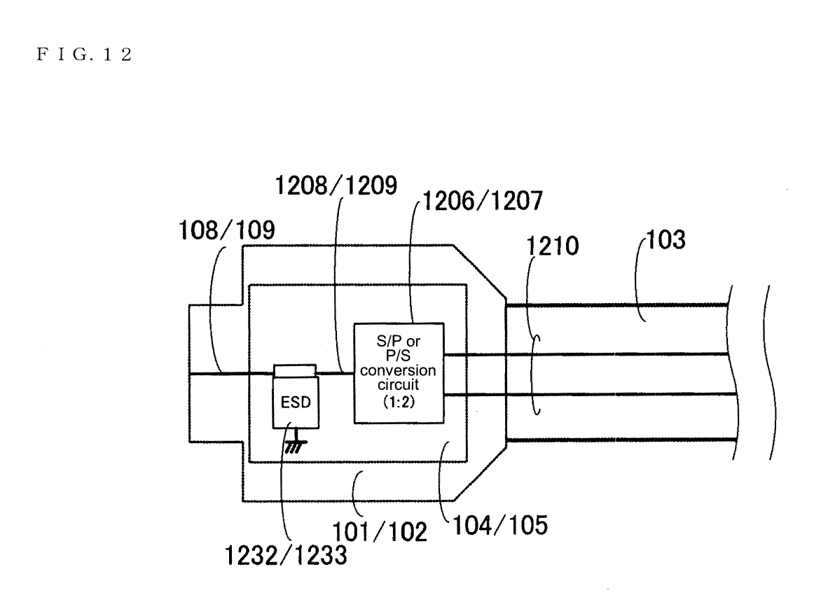

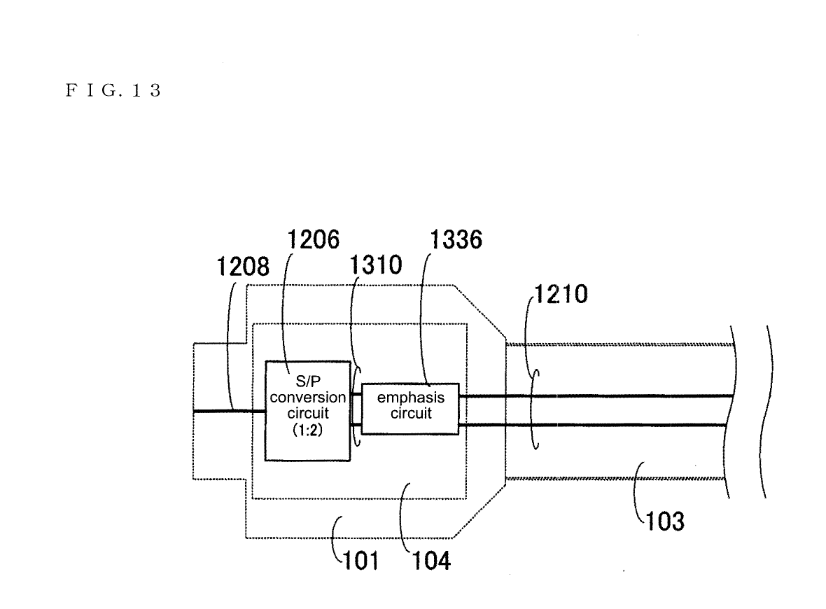

FIG. 12 is an illustration of first and second plugs 101 and 102 according to an exemplary embodiment 10 of the present invention. Any structural elements of FIG. 12 configured identically or similarly to those illustrated in FIGS. 1 and 3 will not be described, with the same reference symbols simply attached thereto. The serial-parallel and parallel-serial conversion circuits according to the present exemplary embodiment are a serial-parallel conversion circuit 1206 and a parallel-serial conversion circuit 1207 configured for 1:2 serial/parallel mutual conversion, however, the present exemplary embodiment is not necessarily limited thereto. Because the serial-parallel conversion circuit 1206 and the parallel-serial conversion circuit 1207 configured for 1:2 serial/parallel mutual conversion are provided, a parallel single-end signal lines 1210 provided in the cable body 103 is provided with two signal lines. The present exemplary embodiment is applicable to the communication cable provided with the serial-parallel conversion circuit 106 and the parallel-serial conversion circuit 107 (configured for 1:4 serial/parallel mutual conversion).

The present exemplary embodiment is structurally characterized in that first and second internal substrates 104 and 105 are respectively provided with ESD protection circuits 1232 and 1233. An ESD suppressor, diode, or barrister, for example, constitutes the ESD protection circuit 1232, 1233.

The ESD protection circuit 1232 is provided in a signal input unit of the serial-parallel conversion circuit 1206, which is an intermediate position between the serial-parallel conversion circuit 1206 and the first serial single-end signal line 108. The ESD protection circuit 1233 is provided in a signal output unit of the parallel-serial conversion circuit 1207, which is an intermediate position between the parallel-serial conversion circuit 1207 and the second serial single-end signal line 109. A reference numeral 1208 illustrated in the drawing is a serial single-end signal line which connects the ESD protection circuit 1232 to the serial-parallel conversion circuit 1206. A reference numerals illustrated in the drawing is a serial single-end signal line which connects the ESD protection circuit 1233 to the parallel-serial conversion circuit 1207.

In the event of ESD (Electrostatic Discharge) when terminals of the first, second plug 101, 102 are contacted by someone, the ESD can be curbed by the ESD protection circuit 1232, 1233. This blocks any signals having a large instantaneous voltage from entering internal circuits of the first, second plug 101, 102, thereby improving the ESD resistance of the communication cable.

Though the 1:2 serial/parallel mutual conversion is employed in the present exemplary embodiment, the serial/parallel mutual conversion may be performed in the proportion of 1:N or N:1 (N is a positive integral number). To flexibly respond to a plurality of pairs of serial-parallel and parallel-serial conversions, the cable body 103 may include a plurality of combinations of paired serial-parallel conversion circuits and parallel-serial conversion circuits, a plurality of pairs of ESD protection circuits, and signal lines respectively connected thereto. The cable body 103 may include therein other signal lines, for example, power line, control line, and clock line. The signal lines of the cable body 103 may be metal lines, coaxial lines, parallel metal lines, stranded lines, flexible cables, or shielded signal lines.

### Exemplary Embodiment 11

FIG. 13 is an illustration of a first plug 101 according to an exemplary embodiment 11 of the present invention. Any structural elements of FIG. 13 configured identically or similarly to those illustrated in FIGS. 1 and 3 will not be described, with the same reference symbols simply attached thereto. The serial-parallel conversion circuit according to the present exemplary embodiment is a serial-parallel conversion circuit 1206 configured for 1:2 serial/parallel mutual conversion, however, the present exemplary embodiment is not necessarily limited thereto. Because the serial-parallel conversion circuit 1206 configured for 1:2 serial/parallel mutual conversion is provided, parallel single-end signal lines 1210 provided in the cable body 103 is provided with two signal lines. The present exemplary embodiment is applicable to the communication cable provided with the serial-parallel conversion circuit 106 and the parallel-serial conversion circuit 107 (configured for 1:4 serial/parallel mutual conversion).

The present exemplary embodiment is structurally characterized in that the first internal substrate 104 is provided with an emphasis circuit 1336. The emphasis circuit 1336 is provided in a signal output unit of the serial-parallel conversion circuit 1206, which is an intermediate position between the serial-parallel conversion circuit 1206 and the parallel single-end signal lines 1210. A reference numeral 1310 illustrated in the drawing is parallel single-end signal lines which connects the emphasis circuit 1336 to the serial-parallel conversion circuit 1206.

When the parallel single-end signal lines 1210 of the cable body 103 are diametrically reduced, resistance components increase, resulting in a large level of signal attenuation. The present exemplary embodiment amplifies a signal using the emphasis circuit 1336 and outputs the amplified signal to the cable body 103, thereby correcting the level of signal attenuation. This technical characteristic can diametrically downsize the cable body 103, while maintaining the fast signal transmission.

Though the present exemplary embodiment describes the 1:2 serial/parallel mutual conversion, the serial/parallel mutual conversion may be performed in the proportion of 1:N or N:1 (N is a positive integral number). To flexibly respond to a plurality of pairs of serial-parallel and parallel-serial conversions, the cable body 103 may include a plurality of combinations of paired serial-parallel conversion circuits and parallel-serial conversion circuits, a plurality of emphasis circuits, and signal lines respectively connected thereto. The cable body 103 may include therein other signal lines, for example, power line, control line, and clock line. The signal lines of the cable body 103 may be metal lines, coaxial lines, parallel metal lines, stranded lines, flexible cables, or shielded signal lines.

### Exemplary Embodiment 12

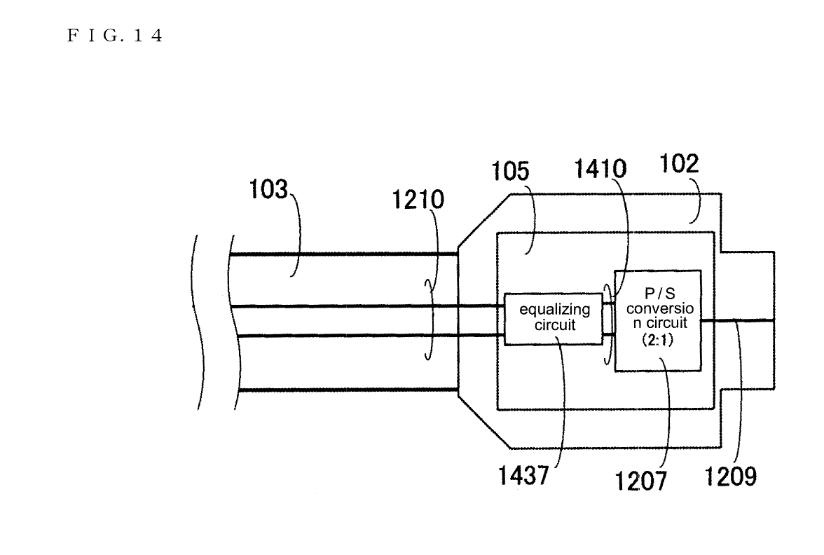

FIG. 14 is an illustration of a second plug 102 according to an exemplary embodiment 12 of the present invention. Any structural elements of FIG. 14 configured identically or similarly to those illustrated in FIGS. 1 and 3 will not be described, with the same reference symbols simply attached thereto. The serial-parallel conversion circuit according to the present exemplary embodiment is a serial-parallel conversion circuit 1207 configured for 1:2 serial/parallel mutual conversion, however, the present exemplary embodiment is not necessarily limited thereto. Because the parallel-serial conversion circuit 1207 configured for 1:2 serial/parallel mutual conversion is provided, parallel single-end signal lines 1210 provided in the cable body 103 are provided with two signal lines. The present exemplary embodiment is applicable to the communication cable provided with the serial-parallel conversion circuit 106 and the parallel-serial conversion circuit 107 (configured for 1:4 serial/parallel mutual conversion).

The present exemplary embodiment is structurally characterized in that the second internal substrate 105 is provided with an equalizing circuit 1437. The equalizing circuit 1437 is provided in a signal input unit of the parallel-serial conversion circuit 1207, which is an intermediate position between the parallel-serial conversion circuit 1207 and the parallel single-end signal lines 1210. A reference numeral 1410 illustrated in the drawing are parallel single-end signal lines which connects the equalizing circuit 1437 to the parallel-serial conversion circuit 1207.

When the parallel single-end signal lines 1210 of the cable body 103 are diametrically reduced, resistance components increase, resulting in a large level of signal attenuation. The present exemplary embodiment amplifies a signal transmitted through the cable body 103 using the equalizing circuit 1437 and outputs the amplified signal to the parallel-serial conversion circuit 1207, thereby correcting the level of signal attenuation. Therefore, the cable body 103 can be diametrically reduced without undermining a high-speed signal transmission.

Though the present exemplary embodiment describes the 1:2 serial/parallel mutual conversion, the serial/parallel mutual conversion may be performed in the proportion of 1:N or N:1 (N is a positive integral number). To flexibly respond to a plurality of pairs of serial-parallel and parallel-serial conversions, the cable body 103 may include a plurality of combinations of paired serial-parallel conversion circuits and parallel-serial conversion circuits, a plurality of emphasis circuits, and signal lines respectively connected thereto. The cable body 103 may include therein other signal lines, for example, power line, control line, and clock line. The signal lines of the cable body 103 may be metal lines, coaxial lines, parallel metal lines, stranded lines, flexible cables, or shielded signal lines.

### INDUSTRIAL APPLICABILITY

The communication cable according to the present invention is suitably used as communication cables used in high-speed serial interfaces, such as HDMI and USB, which are expected to further increase a signal transmission speed in the future.

### DESCRIPTION OF REFERENCE SYMBOLS

101 first plug
102 second plug
103 cable body
104 first internal substrate
105 second internal substrate
106, 306, 506, 606, 1006, 1206 serial-parallel conversion circuit
107, 307, 507, 607, 1007, 1207 parallel-serial conversion circuit
108 first serial single-end signal line
109 second serial single-end signal line
308 first serial differential signal line
309 second serial differential signal line
110, 1210, 1310, 1410 parallel single-end signal lines
211, 212, 213, 214, 215, 420, 421, 422, 423, 712, 713, 714, 715, 812, 813, 814, 815, 911, 912, 913, 914, 915 waveform
310, 1010 parallel differential signal lines
316, 317, 319, 320 signal line
318, 1026, 1027, 1130, 1131, 321, 322 differential signal line pair
1024, 1025, 1128, 1129 common mode filter
1208, 1209 serial single-end signal line
1232, 1233 ESD protection circuit
1336 emphasis circuit
1437 equalizing circuit

1. (canceled)

2. (canceled)

3. A communication cable, comprising:
a cable body having a parallel signal line;
a first plug provided on one end of the cable body to connect one end of the parallel signal line to outside;
a second plug provided on another end of the cable body to connect another end of the parallel signal line to outside;
a serial-parallel conversion circuit provided in the first plug to convert a first serial signal inputted from outside to the first plug into a parallel signal and output the parallel signal to the parallel signal line; and
a parallel-serial conversion circuit provided in the second plug to convert the parallel signal inputted from the parallel signal line to the second plug into a second serial signal and output the second serial signal to outside, wherein
first delay lines respectively having different delay amounts are respectively connected to input terminals of a plurality of signal lines constituting the parallel signal line, and the serial-parallel conversion circuit thereby generates the parallel signals so that the parallel signals respectively have different output timings, and
second delay lines respectively having different delay amounts are respectively connected to output terminals of the signal lines, and the serial-parallel conversion circuit thereby equalizes the delay amounts of the first delay lines and delay amounts of the second delay lines which are summed in the respective signal lines in all of the signal lines.

4. The communication cable as claimed in claim 3, wherein
the first and second serial signals are both serial differential signals, and the parallel signal is a parallel differential signal.

5. The communication cable as claimed in claim 3, wherein
the first and second serial signals are both serial single-end signals, and the parallel signal is a parallel differential signal.

6. The communication cable as claimed in claim 3, wherein
the first serial signal is a serial differential signal, the parallel signal is a parallel single-end signal, and the second serial signal is a serial differential signal.

7. The communication cable as claimed in claim 3, wherein
the serial-parallel conversion circuit generates the parallel signal so that the parallel signal has an amplitude smaller than an amplitude of the first serial signal.

8. The communication cable as claimed in claim 7, wherein
the serial-parallel conversion circuit generates the parallel signal so that the parallel signal has an amplitude smaller than an amplitude of the second serial signal.

9. The communication cable as claimed in claim 8, wherein
the serial-parallel conversion circuit is voltage-driven, and
a drive voltage of the serial-parallel conversion circuit is continuously lowered until the amplitude of the parallel signal falls below the amplitude of the second serial signal.

10. The communication cable as claimed in claim 8, wherein
the serial-parallel conversion circuit is current-driven, and
a drive current of the serial-parallel conversion circuit is continuously lowered until the amplitude of the parallel signal falls below the amplitude of the second serial signal.

11. (canceled)

12. (canceled)

13. (canceled)

14. The communication cable as claimed in claim 3, wherein
the serial-parallel conversion circuit generates the parallel signal so that a signal transition time of the parallel signal is longer than a signal transition time of the first serial signal.

15. The communication cable as claimed in claim 14, wherein
an output drive circuit of the serial-parallel conversion circuit is arranged to have a current capacity lower than a current capacity of the parallel-serial conversion circuit so that the signal transition time of the parallel signal in the serial-parallel conversion circuit is longer than the signal transition time of the first serial signal.

16. The communication cable as claimed in claim 14, wherein
a low-pass filter is provided in an output terminal of the serial-parallel conversion circuit so that the signal transition time of the parallel signal in the serial-parallel conversion circuit is longer than the signal transition time of the first serial signal.

17. The communication cable as claimed in claim 14, wherein
the serial-parallel conversion circuit generates the parallel signal so that the signal transition time of the parallel signal is longer than a signal transition time of the second serial signal.

18. (canceled)

19. (canceled)

20. (canceled)

21. (canceled)

22. The communication cable as claimed in claim 3, wherein
at least one of a signal input unit of the serial-parallel conversion circuit and a signal output unit of the parallel-serial conversion circuit is provided with an ESD protection circuit.

23. The communication cable as claimed in claim 3, wherein
a signal output unit of the serial-parallel conversion circuit is provided with an emphasis circuit.

24. The communication cable as claimed in claim 3, wherein
a signal input unit of the parallel-serial conversion circuit is provided with an equalizing circuit.
